(19) United States
(12) Patent Application Publication
(10) Pub. No.: US 2002/0154249 A1
(43) Pub. Date: Oct. 24, 2002

(54) Intermediate frequency circuit of television tuner, which is not influenced by saw filter characteristics

(75) Inventor: Akira Kawamura, Fukushima-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 10/124,678

(22) Filed: Apr. 17, 2002

(30) Foreign Application Priority Data
Apr. 19, 2001 (JP) 2001-121231

(51) Int. Cl. H04N 5/50

(52) U.S. Cl. 348/731

(57) ABSTRACT

An SAW filter is provided between an intermediate frequency amplifier and a video detector, an intermediate frequency tuning circuit for tuning a frequency to an almost center frequency in an intermediate frequency band is provided between a mixer and the intermediate frequency amplifier, and an intermediate frequency signal is taken from the intermediate frequency tuning circuit and input to a phase control circuit.

### BACKGROUND OF THE INVENTION

1. Field of the Invention

The present invention relates to an intermediate frequency circuit of a television tuner.

2. Description of the Related Art

FIG. 5 shows the configuration of an intermediate frequency circuit of a conventional television tuner. To a mixer 31 constructed by a balancing circuit, a television signal RF of a reception channel selected by a not-shown tuning circuit is input and a local oscillation signal from a local oscillator 32 is input. The local oscillator 32 also takes the form of a balancing circuit. An intermediate frequency signal output from the mixer 31 passes through a tuning circuit 33 and input to an intermediate frequency amplifier 34. Although the intermediate frequency amplifier 34 takes the form of a balancing circuit, an amplified intermediate frequency signal is output as an unbalanced signal.

Although an SAW filter 35 provided at the next stage of the intermediate frequency amplifier 34 takes the form of a balancing circuit, the intermediate frequency signal which is not balanced is received. To obtain a vestigial side band characteristic and to lessen interference from neighboring channels and interference of sound signals of a channel of itself, the SAW filter 35 has sharp selectivity characteristics and attenuation pole frequency as shown in FIG. 6.

A specified video carrier F1 (for example, 58.75 MHz in Japanese specification) in the intermediate frequency band is determined to be slightly lower than the pass band. As shown in FIG. 6, although a chrominance subcarrier F2 is at almost the same level as the video carrier F1, a sound carrier F3 is lower than the chrominance subcarrier F2 and video carrier F1 by tens dB. Further, the positions −F3 and +F1 corresponding to a specified sound carrier of a neighboring channel on the lower side (before frequency conversion) and a specified video carrier of a neighboring channel on the higher side, respectively, are attenuation pole frequencies, which attenuate considerably from the pass band.

An intermediate frequency signal output from the SAW filter 35 is input to a video detector 37 via a variable gain amplifier 36 controlled by an AGC voltage. The video detector 37 is actually constructed in a double balancing type, and an oscillation signal for synchronizing detection from a voltage-controlled oscillator 38 is input to the video detector 37. The voltage-controlled oscillator 38 has therein a varactor diode (not shown) and is constructed so that as a control voltage applied to the varactor diode decreases, an oscillation frequency becomes higher. The voltage-controlled oscillator 38 is controlled by an APC circuit (phase control circuit) 39 so that its oscillation frequency becomes equal to the frequency of the video carrier. For this purpose, an intermediate frequency signal and an oscillation signal are input to the phase control circuit 39.

The phase control circuit 39 has therein a phase comparator and outputs an error voltage proportional to the phase difference (frequency difference) between the two input signals. For example, if the frequency of the video carrier is higher than the oscillation frequency of the voltage-controlled oscillator 38, the error voltage becomes a negative voltage. If the oscillation frequency of the voltage-controlled oscillator 38 is higher than the frequency of the video carrier, the error voltage becomes a positive voltage. When the oscillation frequency of the voltage-controlled oscillator 38 and the frequency of the video carrier are equal to each other, the error voltage becomes zero. Therefore, when the error voltage is applied as a control voltage to the voltage-controlled oscillator 38, the oscillation frequency becomes equal to the frequency of the video carrier. A closed loop of the voltage-controlled oscillator 38 and the phase control circuit 39 therefore constructs a PLL circuit.

In the above configuration, for example, when the oscillation frequency of the local oscillator 32 changes to the higher side due to a change in the environmental conditions such as temperature, the oscillation frequency of the voltage-controlled oscillator 38 also changes to the higher side by the above operation. As a result, the video carrier in the intermediate frequency signal and the oscillation signal of the voltage-controlled oscillator 38 input to the video detector 37 become always the same, so that a normal synchronizing detecting operation is assured. Similarly, when the oscillation frequency of the local oscillator 32 changes to the lower side, the oscillation frequency of the voltage-controlled oscillator 38 accordingly changes to the lower side.

As described above, when the local oscillation frequency of the local oscillator 32 changes to the higher side, in response to it, the actual video carrier included in the intermediate frequency signal changes to the higher side. However, since the selectivity characteristic of the SAW filter 35 sharply attenuates on the side higher than the pass band, the level of the actual video carrier becomes extremely low due to a slight frequency change.

Due to this, the range C of the frequency error in which the phase comparator in the phase control circuit 39 can perform comparing operation becomes narrow as shown in FIG. 7. When the local oscillation frequency changes to the frequency difference exceeding the range C, it becomes impossible to output the control voltage. Therefore, it becomes impossible to control the oscillation frequency of the voltage-controlled oscillator. As a result, the video detector 37 becomes unable to perform synchronizing detection and the voltage-controlled oscillator 38 enters a frequency unlocked state.

### SUMMARY OF THE INVENTION

An object of the invention is to provide an intermediate frequency circuit of a television tuner in which even when an oscillation frequency of a local oscillator changes to a higher side, the oscillation frequency for synchronizing detection is controlled to be equal to a frequency of a video carrier in an intermediate frequency signal without being influenced by a selectivity characteristic of an SAW filter.

As a means for achieving the object, there is provided an intermediate frequency circuit of a television tuner, including: a mixer and a local oscillator for frequency conversion; an intermediate frequency amplifier provided at a post stage of the mixer; a video detector provided at a post stage of the intermediate frequency amplifier, for detecting an intermediate frequency signal output from the mixer; a voltage-controlled oscillator for supplying an oscillation signal for synchronizing detection to the video detector; and a phase control circuit for comparing a phase of a video carrier included in the intermediate frequency signal with a phase of the oscillation signal and, according to the phase difference, controlling a frequency of the oscillation signal to be equal to a frequency of the video carrier, wherein an SAW filter is provided between the intermediate frequency amplifier and the video detector, an intermediate frequency tuning circuit for tuning a frequency to an almost center frequency in an intermediate frequency band is provided between the mixer and the intermediate frequency amplifier, and the intermediate frequency signal is taken from the intermediate frequency tuning circuit and input to the phase control circuit.

A skirt characteristic in a position apart from the tuning frequency on a tuning curve of the intermediate frequency tuning circuit is set to 5 dB or less per MHz.

The intermediate frequency tuning circuit is constructed by a single tuning circuit.

### BRIEF DESCRIPTION OF THE DRAWINGS

FIG. 1 is a circuit diagram showing the configuration of an intermediate frequency circuit of a television tuner of the invention.

FIG. 2 is a diagram showing a selectivity characteristic of an intermediate frequency tuning circuit used for the intermediate frequency circuit of the television tuner of the invention.

FIG. 3 is a diagram showing a selectivity characteristic of an SAW filter used for the intermediate frequency circuit of the television tuner of the invention.

FIG. 4 is a characteristic diagram of a control voltage of a phase control circuit in the intermediate frequency circuit of the television tuner of the invention.

FIG. 5 is a circuit diagram showing the configuration of an intermediate frequency circuit of a conventional television tuner.

FIG. 6 is a diagram showing a selectivity characteristic of an SAW filter used for the intermediate frequency circuit of the conventional television tuner.

FIG. 7 is a characteristic diagram of an output control voltage of a phase control circuit in the intermediate frequency circuit of the conventional television tuner.

### DETAILED DESCRIPTION OF THE PREFERRED EMBODIMENTS

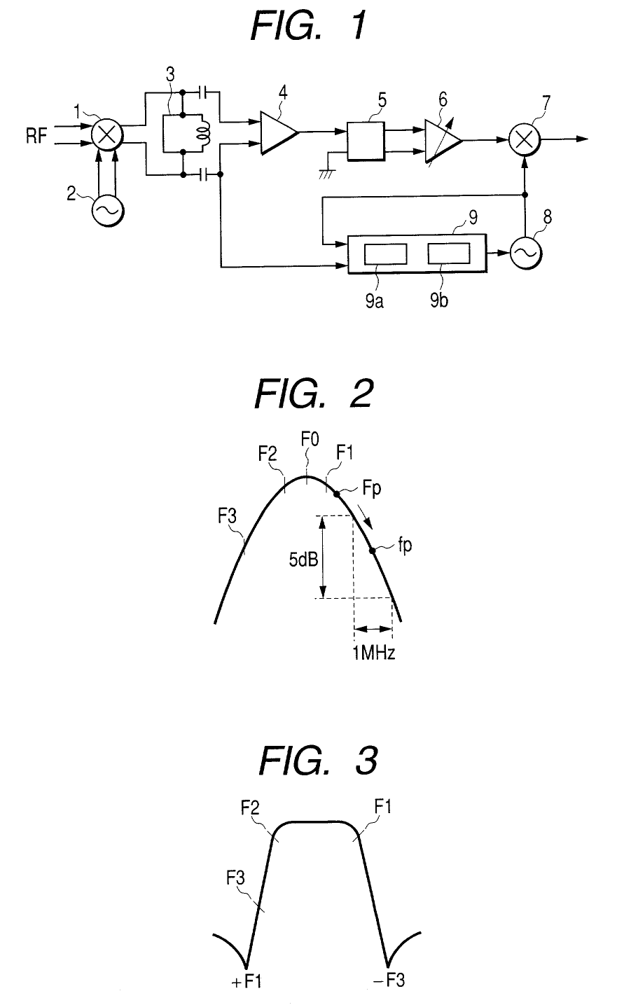

FIG. 1 shows the configuration of an intermediate frequency circuit of a television tuner of the invention. A mixer 1 takes the form of a balancing circuit. A television signal RF of a reception channel selected by a not-illustrated tuning circuit from the ante stage is input to the mixer 1. A local oscillation signal from a local oscillator 2 is also input to the mixer 1. The local oscillator 2 also takes the form of a balancing circuit. An intermediate frequency signal output from the mixer 1 is input to a balanced intermediate frequency tuning circuit 3.

The intermediate frequency tuning circuit 3 is a single tuning circuit and, as shown in FIG. 2, its tuning frequency F0 is adjusted to be an almost center frequency (56.5 MHz in Japanese specification) of a specified intermediate frequency band of a television.

A specified video carrier F1 (58.75 MHz) in the intermediate frequency band and a chrominance subcarrier F2 (55.17 MHz) are positioned at levels lower than the tuning frequency F0 on the selectivity characteristic (skirt characteristic) by about 1 dB and a specified sound carrier F3 (54.25 MHz) is positioned lower than those carriers. The selectivity characteristic related to a circuit Q is relatively gentle, and the skirt characteristic (gradient) is 5 dB per MHz at the maximum.

Therefore, when the frequency of the local oscillator 2 is accurate, an actual video carrier Fp, an actual chrominance subcarrier Fc, and an actual sound carrier Fs (those will be called video carrier and the like) included in the intermediate frequency signal are positioned at the frequencies F1, F2, and F3, respectively.

The intermediate frequency signal passed through the intermediate frequency tuning circuit 3 is input to a balanced intermediate frequency amplifier 4.

An SAW filter 5 provided at the following stage of the intermediate frequency amplifier 4 takes the form of a balancing circuit. The intermediate frequency signal is input in an unbalanced state and is output in a balanced state. To obtain a vestigial side band characteristic and to lessen interference from neighboring channels and interference from a sound signal of an own channel, the SAW filter 5 has a sharp selectivity characteristic on the outside of the pass band and has attenuation pole frequencies as shown in FIG. 3.

Concretely, the selectivity characteristic is obtained such that the specified video carrier F1 in the intermediate frequency band is positioned slightly lower than the pass band. The specified chrominance subcarrier F2 is at almost the same level as the video carrier F1, and the specified sound carrier F3 is lower than the chrominance subcarrier F2 and video carrier F1 by tens dB. Further, an attenuation pole frequency for attenuating the specified sound carrier −F3 in the lower-side neighboring channel before being frequency converted is provided on the side higher than the specified video carrier F1. An attenuation pole frequency for attenuating the specified video carrier +F1 in the higher-side neighboring channel is provided on the side lower than the specified sound carrier F2.

An intermediate frequency signal output from the SAW filter 5 is input to a video detector 7 via a variable gain amplifier 6 which is gain-controlled by an AGC voltage. The video detector 7 is actually constructed in a known double balancing type, but its concrete configuration diagram is not shown. An oscillation signal for synchronizing detection from a voltage-controlled oscillator 8 is input to the video detector 7. The voltage-controlled oscillator 8 has therein a varactor diode (not shown) and is constructed so that as a control voltage applied to the varactor diode decreases, an oscillation frequency becomes higher.

The voltage-controlled oscillator 8 and an APC (automatic phase control) circuit 9 construct a PLL circuit, and the voltage-controlled oscillator 8 is controlled so that its oscillation frequency becomes equal to the frequency of the actual video carrier Fp included in the intermediate frequency signal. An end of the intermediate frequency tuning circuit 3 is coupled to an input terminal of the APC circuit 9 and an unbalanced intermediate frequency signal is input to the input terminal. To the other input terminal, an oscillation signal from the voltage-controlled oscillator 8 is input.

The APC circuit 9 has a phase comparator 9a and a limiter 9b, and the phase comparator 9a compares the actual video carrier Fp included in the input intermediate frequency signal with the oscillation signal of the voltage-controlled oscillator 8 and outputs an error voltage proportional to the phase difference (frequency difference) between the two input signals. For example, if the frequency of the video carrier Fp is higher than the oscillation frequency of the voltage-controlled oscillator 8, the error voltage becomes a negative voltage. If the oscillation frequency of the voltage-controlled oscillator 8 is higher than the frequency of the video carrier Fp, the error voltage becomes a positive voltage. When the oscillation frequency of the voltage-controlled oscillator 8 and the frequency of the video carrier Fp are equal to each other, the error voltage becomes zero. The limiter 9b amplifies the error voltage and limits it to a predetermined level and, when a phase difference is equal to or larger than a predetermined value (from 1.5 MHz to 2 MHz in frequency conversion), decreases the voltage to zero.

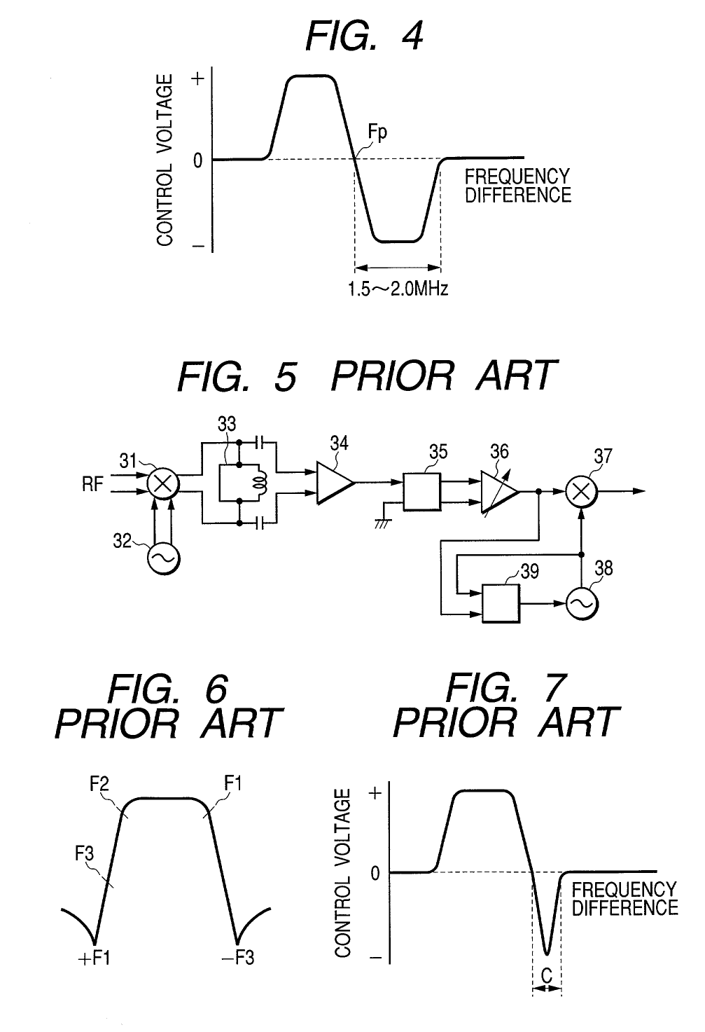

Therefore, a voltage having an almost inverse S letter shaped discrimination characteristic for the phase difference as shown in FIG. 4 is output from the APC circuit 9. When the voltage is applied as a control voltage to the voltage-controlled oscillator 8, the oscillation frequency of the voltage control oscillator 8 becomes equal to the frequency of the video carrier Fp.

In the above configuration, for example, when the oscillation frequency of the local oscillator 2 changes to the higher side due to a change in the environmental conditions such as temperature, the frequency of the actual video carrier Fp and the like becomes higher to the higher side fp along a tuning curve of the tuning circuit 3, so that the level of the video carrier Fp decreases. However, by a frequency change of about 2 MHz, the level drop is at most about 10 dB. Consequently, the phase comparator 9a can perform a comparing operation with the oscillation signal in response to the video carrier Fp, and an error voltage can be output.

As a result, the oscillation signal of the voltage-controlled oscillator 8 also changes to the higher side by the above-described operation, and the actual video carrier Fp included in the intermediate frequency signal input to the video detector 7 and the oscillation signal of the voltage-controlled oscillator 8 become always the same. Consequently, when the change in the oscillation frequency of the local oscillator 2 is up to 1.5 MHz, a normal synchronizing detecting operation is assured.

Since the intermediate frequency tuning circuit is a single tuning circuit, the circuit Q can be easily changed. Therefore, the skirt characteristic can be easily properly set in accordance with a change range (that is, the frequency change range of the video carrier) of the oscillation frequency of the local oscillator.

As described above, in the intermediate frequency circuit of a television tuner of the invention, the SAW filter is provided between the intermediate frequency amplifier and the video detector, the intermediate frequency tuning circuit for tuning a frequency to an almost center frequency in an intermediate frequency band is provided between the mixer and the intermediate frequency amplifier, and the intermediate frequency signal is taken from the intermediate frequency tuning circuit and input to the phase control circuit. Consequently, the video carrier included in the intermediate frequency signal is not influenced by the sharp selectivity characteristic of the SAW filter, so that the oscillation frequency of the voltage-controlled oscillator for outputting the oscillation signal for video detection can be changed in a wider range in accordance with the frequency change in the video carrier.

Since the skirt characteristic in a position apart from the tuning frequency on a tuning curve of the intermediate frequency tuning circuit is set to 5 dB or less per MHz, a wider frequency change can be reliably dealt with.

Since the intermediate frequency tuning circuit is constructed by a single tuning circuit, the skirt characteristic can be easily set in accordance with the frequency change range of the video carrier.

What is claimed is:

1. An intermediate frequency circuit of a television tuner, comprising:
a mixer and a local oscillator for frequency conversion;
an intermediate frequency amplifier provided at a post stage of the mixer;
a video detector provided at a post stage of the intermediate frequency amplifier, for detecting an intermediate frequency signal output from the mixer;
a voltage-controlled oscillator for supplying an oscillation signal for synchronizing detection to the video detector; and
a phase control circuit for comparing a phase of a video carrier included in the intermediate frequency signal with the phase of the oscillation signal and, according to the phase difference, controlling a frequency of the oscillation signal to be equal to a frequency of the video carrier,
wherein an SAW filter is provided between the intermediate frequency amplifier and the video detector, wherein an intermediate frequency tuning circuit for tuning a frequency to an almost center frequency in an intermediate frequency band is provided between the mixer and the intermediate frequency amplifier, and wherein the intermediate frequency signal is taken from the intermediate frequency tuning circuit and input to the phase control circuit.

2. The intermediate frequency circuit of a television tuner according to claim 1, wherein a skirt characteristic in a position apart from the tuning frequency on a tuning curve of the intermediate frequency tuning circuit is set to 5 dB or less per MHz.

3. The intermediate frequency circuit of a television tuner according to claim 2, wherein the intermediate frequency tuning circuit is constructed by a single tuning circuit.
